(19) United States
(12) Patent Application Publication
(10) Pub. No.: US 2022/0306397 A1
(43) Pub. Date: Sep. 29, 2022

(54) TRANSPORT DEVICE AND METHOD FOR POSITION MONITORING

(71) Applicant: HOMAG GmbH, Schopiioch (DE)

(72) Inventors: David FRICK, Neustetten (DE); Markus MORLOCK, Freudenstadt (DE)

(21) Appl. No.: 17/605,551

(22) PCT Filed: Apr. 23, 2020
(86) PCT No.: PCT/EP2020/061307

§ 371 Date: Oct. 21, 2021

(30) Foreign Application Priority Data
Apr. 24, 2019 (DE) 10 2019 110 568.4

(51) Int. Cl. B65G 43/08; B65G 17/40; B23Q 7/16; B23Q 17/22; B23Q 17/24

(52) U.S. Cl. CPC B65G 43/08; B65G 17/40; B23Q 7/16; B23Q 17/22; B23Q 17/248; B65G 2203/044; B65G 2203/0233

(57) ABSTRACT

A transport device for transporting workpieces which preferably consist, at least in part, of wood, wood materials, plastics material, or the like, comprises, according to this application, a transport apparatus which is configured such that it can move along a first direction, and wherein the transport apparatus comprises a marking which comprises a pattern along the first direction.

### TECHNICAL FIELD

The present invention relates to a device for position monitoring for a workpiece during travel, and to a method for position monitoring for a workpiece passing by, wherein the workpieces preferably consist, at least in part, of wood, wood materials, plastics material, or the like.

### PRIOR ART

In the prior art, transport devices for transporting workpieces are known, in which workpieces travel past processing devices, such that the workpieces can be processed by the stationary processing devices during travel. In particular, rolling and sliding chains are used here, wherein the workpiece is conveyed in a manner clamped between the chain and a belt.

A central aspect of the transport devices known in the prior art consists in the position monitoring of the workpieces. Processing work in a transport device requires a high degree of accuracy of the workpiece position. In the prior art, position monitoring by means of scanning elements is known, wherein the workpieces actuate a movable component when passing by said component, as a result of which the position of a workpiece in the conveying direction of the transport device is ascertained.

However, mechanical scanning elements have several disadvantages: Inter alia, the flexibility of the transport device relative to changing workpiece geometries is low, the costs for maintenance, upkeep and cleaning of scanning elements of this kind are high, and surfaces, in particular highly sensitive surfaces, may be damaged on account of the mechanical contact of the workpiece.

Typically, the position in the feed direction is calculated using a rotary encoder and a position switch. However, in particular in the case of cost-effective chains, the problem arises that the chain links lengthen over the course of the lifecycle and under loading, as a result of which, when calculating the position, position deviations of several millimeters arise between the calculated position and the actual position on account of the values from the rotary encoder and position switch, such that a further scanning element or a sensor is required, which detects the actual position, in order to perform the processing to the required degree of accuracy.

### SUMMARY OF THE INVENTION

Against the background of the known transport devices, an object of the transport device of the present invention is that of providing a cost-effective system by means of which it is possible to precisely determine the position of an individual chain link in the transport device along the conveying direction.

In particular, an object of the present invention is that of determining the position of a workpiece by means of precise detection of individual transport means, such as individual chain links of a transport device.

This object is achieved by a transport device according to claim 1 and by a method for determining a position of a transport device according to claims 11 and 16, as well as by a processing method for a workpiece in a transport device according to claim 23. Advantageous developments of these aspects of the invention can be found in the respective dependent claims.

Advantages of the present invention are increased flexibility, lower costs, lower servicing and repair outlay, higher processing quality, as well as prevention of damage to highly sensitive surfaces. Furthermore, the present invention makes it possible to calculate a very precise position of the workpiece, while cost-effective chains are used. Thus, automatic control of the feed can take place, depending on the state of the chain. Furthermore, for example the throughput rate of the processed workpieces can be increased, since no reduction of the feed rate is necessary in order to reach the required tolerances due to the improved positioning accuracy, in particular in the case of dynamic stress and loading states.

Further advantages of the present invention are the possibility for state monitoring of the transport device, and the maintenance and upkeep based on this. Servicing measures are also possible.

Overall, the present invention makes it possible to allow for a quicker feed rate at the same quality, which can lead to more efficient utilization of the machines.

(1) A transport device according to the invention for transporting workpieces according to a first aspect of the invention, which preferably consist, at least in part, of wood, wood materials, plastics material, or the like, comprises at least one transport apparatus which is configured such that it can move along a first direction, wherein the transport device comprises a marking which comprises a pattern along the first direction.

Making the marking on the transport apparatus firstly makes it possible to identify a transport means, for example with respect to a non-marked transport means, and secondly the marking on one transport apparatus makes it possible for the transport apparatus to be divided, along a first direction, into a region of the transport device which is located in front of the marking in the first direction, into a region which is located at the level of the marking in the first direction, and a region which is located behind the marking in the first direction.

The pattern of the marking makes it possible to subdivide the marking in the first direction, and thus to finely divide the above-described region at the level of the marking.

An advantage of said patterned marking is that it is possible to very precisely detect the position of the relevant transport apparatus during travel in the first direction, which may require knowledge of the position of the marking on the transport unit, and knowledge of the pattern on the marking.

A marking of this kind can be used not only for position determination along the marking, but also, in a manner similar to a barcode, for clear identification of one marking with respect to another marking. An identification of this kind can take place both manually and automatically, during travel. An automatic identification allows for the transport device to be incorporated in an Internet of Things environment. As a result, higher productivity, in particular in networked production environments, can be achieved.

(2) The transport device can preferably receive and transport a workpiece.

(3) The marking of the transport device is preferably an optical marking, a metal marking, an inductive marking, or a magnetic marking.

An advantage of an optical marking of this kind, compared with a conceivable non-optical marking, for example a magnetic marking or a marking by way of application of scanning elements, is that the optical marking can be detected by an optical sensor, such as a camera or a laser transceiver apparatus.

A metal, inductive or magnetic marking in turn has the advantage that no optical elements such as lenses or beam paths are required for reading the marking, as a result of which the position determination can also take place in contaminated environments. Non-optical markings are expedient in particular in the field of wood and plastics processing, since wood and plastics chips have a usually negligible influence on inductive or magnetic properties, and therefore, in particular compared with an optical marking, operation is possible when the space between the sensor and marking is contaminated.

(4) The pattern of the transport device can preferably be an incremental pattern, particularly preferably an incremental scale.

Within the meaning of this invention, an incremental pattern refers to a pattern which is configured in a first direction such that it comprises a sequence of alternating regions, for example black and white, wherein it is obvious that any color combination which offers a sufficient contrast between the two colors is possible, and the differentiation into black and white regions is selected merely in the interest of a simpler description.

It is noted that it is also possible for more than two colors to be provided, for example black, white and red. In particular, the possibility is mentioned of specifying an individual color for every region along the first direction of the marking, such that it is possible to identify the position along the first direction on account of the color of the region alone.

It is furthermore noted that, although in this case the incremental patterning is described as a color sequence, in the interest of simpler readability, the invention is in no way limited to optical markings. It is thus possible, for example, for “white” to correspond to the magnetic coding “0”, and “black” to correspond to the magnetic coding “1”. Similar applies for patterns comprising more than two colors.

Conceivable alternatives to this preferred embodiment are embodiments in which the pattern is non-incremental, such as a region that is patterned by means of letters printed thereon.

For example, the incremental pattern may be a pattern in which black and white regions alternate along a first direction, such that a black region follows after a white region, a further white region follows after the black region, and a further black region follows after the further white region, and so on. A pattern thus results which is similar to a barcode. The number of white and black regions is not particularly limited, but it is obvious that finer position determination is possible as the number of increments increases.

In principle, the length of the increments along the first direction, and in particular the black and white regions, is not limited, such that it is possible for there to be white regions which are longer, in the first direction, than other white regions, and black regions which are longer, in the first direction, than other black regions. This is advantageous in that, with knowledge of the sequence of the increments and in particular the different lengths of the regions, a determination of the position of the transport apparatus can take place based on a detail of the incremental pattern.

In the event of all the regions of the same color being of the same length along the first direction, reference is made, within the meaning of this application, to an incremental scale. An incremental scale is advantageous in that, with knowledge of the position of the marking on the transport element during travel by counting the regions of the same color (for example black) travelling past a, for example stationary, sensor, and with knowledge of the length of black and white regions, a highly accurate position determination of individual transport apparatus during travel is possible.

(5) The marking of the transport device is preferably arranged on a lateral surface of the transport device.

Conceivable alternatives are application of the marking to the upper face and to the lower face of the transport device.

Compared with application to the upper side, this preferred embodiment is advantageous in that workpieces to be transported are routinely transported on the upper face or on the lower face of a transport device, and thus covering of the marking by the workpiece is prevented.

Furthermore, this preferred application to the side offers simple assembly as well as the possibility of cleaning during travel without interrupting the operation, for example by a laterally applied stationary brush.

(6) The transport device preferably comprises at least one transport apparatus which does not comprise any marking.

In the case of transport devices in which a plurality of transport apparatus is provided, having a known sequence and mutual spacing, this embodiment makes it possible to provide just a subset of the transport apparatus with patterns and nonetheless to sufficiently precisely monitor the position of the transport means, as a result of which costs can be saved compared with an alternative in which a marking is applied to every transport unit.

(7) A transport device preferably comprises a plurality of transport means, wherein the transport apparatuses are interconnected, and are in particular annularly interconnected.

This embodiment is advantageous compared with an embodiment in which a plurality of transport apparatus is provided which are not interconnected, in that firstly the connection of the transport units specifies the mutual spacing of the transport units, and secondly an annular connection makes possible a continuous processing process, similar to a conveyor belt.

(8+9+10) According to the first aspect of the present invention, a transport device preferably comprises a sensor device for reading out the marking, wherein the transport apparatus is in particular configured such that it moves along the first direction relative to the sensor device.

Compared with a possible alternative in which the transport device is not configured having a sensor device, for example a transport device in which the read-out of the marking is performed by eye, this preferred embodiment makes it possible to detect the position of the transport unit automatically and by machine, which increases the processing speed. A transport device, which moves relative to the sensor device, allows for fixed or stationary positioning of the sensor device.

(11) A method according to the invention for determining a position of a transport apparatus along a first direction comprises reading out a region of the marking of a transport device according to the invention, processing an item of information which is obtained from the reading out, comparing a processed item of information with stored information, a determination step in which a change of a current position with respect to a previous position is determined on the basis of the comparison, and a storage step.

This method is advantageous in that, on the basis of the comparison of an item of processed information, obtained from the read-out, for example a counting step of an increment of an incremental scale, and the knowledge of the length along the first direction of an increment, and the knowledge of a position of the transport apparatus before the counting step, a current position of the transport apparatus can be determined precisely.

In the event of the pattern not being an incremental scale, the information from the read-out can for example be an item of information relating to a portion of the pattern, and the stored information can be information relating to the overall structure (and the sequence of the portions) of the pattern. In this case, the determination step contains a step in which the information read out is compared with the stored information, as a result of which precise position determination on the pattern is also possible.

(12) The stored information of the method preferably comprises an item of information relating to the pattern of the marking.

Compared with a step in which the stored information does not include any information relating to the pattern of the marking, for example in a case in which the stored information contains exclusively an item of information relating to a chronologically preceding item of information, the advantage of an item of stored information relating to the pattern of the marking is that the position of the transport unit can be determined exclusively on the basis of a detected portion of the marking.

(13) The storage step preferably comprises storing the processed information. Compared with a storage step which does not involve any storage of the processed information, such as a storage step exclusively comprising a timestamp, a method in which the storage step comprises storing of the processed information makes it possible to determine, in a following processing step, the path travelled since the last step.

(14) The stored information of the method preferably comprises an item of information relating to the position of a transport apparatus prior to reading out the marking of the transport means.

Compared with an alternative embodiment in which the stored information of the method does not comprise any information relating to the position of a transport apparatus prior to reading out the marking of the transport means, for example only an item of information relating to the pattern, this embodiment is advantageous in that it is possible to determine the movement of a transport device between two readout time points.

(15) In the method, a current position, with respect to a fixed reference point, is preferably determined on the basis of the comparison of the change in a current position.

Compared with a method in which no change of the current position is determined, but merely one position, this embodiment allows for a determination of the movement of the transport means.

(16) According to the invention, a method for determining the position of a workpiece in a transport device comprises a step of determining a spacing between a reference point of a marking of a transport apparatus and a reference point of a workpiece.

This method is advantageous in that the position of the workpiece can be determined based on the determination of a position of a marking on a transport means, which allows for precise machining or processing of the workpiece.

(17) In the method for determining the position of the workpiece, the spacing in the first direction is preferably measured.

Compared with a method in which the spacing in another direction is measured, this embodiment is advantageous in that the position of the regions which terminate the workpiece to the front and to the back, in the first direction, can be precisely determined, which is advantageous in particular if these regions are to be processed.

(18) In the method for determining the position of the workpiece, the reference point of the marking is preferably positioned at a front end of the marking, in the first direction.

Compared with an embodiment in which the reference point is not positioned at the front end of the marking, in the first direction, but rather is positioned for example in the center of the marking, this embodiment is advantageous in that the position determination can take place while the marking is moving.

(19) In the method for determining the position of the workpiece, the reference point of the workpiece is preferably positioned at a front end of the workpiece, in the first direction.

Compared with an alternative in which the reference point of the workpiece is not positioned at a front end in the first direction, this embodiment is advantageous in that, in the case of a workpiece of which the front end is to be processed, the processing of the determined data is less complex, and thus less error propagation occurs when calculating the position of the region to be processed.

(20) The method for determining the position of the workpiece preferably comprises a step of determining the position of the reference point of the workpiece with respect to a reference point of the transport device.

Compared with a method that does not comprise this step, for example in which the workpiece is arranged on the transport device without the relative position of the transport device and workpiece being determined, this embodiment is advantageous in that it is possible to precisely determine the position of the regions of the workpiece to be processed during travel.

(21) In the method for determining the position of a workpiece, the transport device is preferably a transport device for transporting workpieces which preferably consist, at least in part, of wood, wood materials, plastics material, or the like, and comprises at least one transport apparatus which is configured such that it can move along a first direction, wherein the transport device comprises a marking which comprises a pattern along the first direction.

Compared with an alternative in which the method comprises the position determination without a marking having a pattern in the first direction, this embodiment is advantageous in that the determination of the position of the transport element can be carried out on the basis of the marking and the pattern, allowing for highly accurate position determination.

(22) In the method for determining the position of the workpiece, the determination of the position of the reference point of the marking preferably comprises a method for determining a position of a transport apparatus along a first direction, comprising the following steps:

reading out a region of the marking of a transport device,
processing an item of information which is obtained from the reading out,
comparing a processed item of information with stored information,
a determination step in which a change of a current position with respect to a previous position is determined on the basis of the comparison, and
a storage step.

This embodiment makes it possible to precisely determine the position of the workpiece during travel.

(23) In a processing method according to the invention for a workpiece in a transport device, the workpiece is processed on a transport device using a tool.

This method makes it possible to process the workpiece during travel.

(24) The workpiece is preferably moved, on the transport means, relative to the tool.

Compared with an alternative in which the workpiece is not moved relative to the tool, this embodiment makes it possible to establish assembly line-like operation.

(25) A relative position of the workpiece with respect to the tool is preferably determined by means of a method for determining the position of a workpiece in a transport device.

This method makes it possible to precisely determine the position of the workpiece during travel and to carry out the processing of the workpiece on the basis of the position determination, leading to a more precise processing result.

(26) According to the invention, in a method for identifying a transport means, the transport apparatus is identified by reading out the marking, wherein at least one of the markings differs from at least one other marking.

A method of this kind makes it possible for individual transport elements to be identified, with respect to other transport elements, in a processing environment.

(27) According to the invention, in a method for controlling a transport device, control of a feed rate is carried out on the basis of an item of information which is obtained from a read-out of at least one of the markings.

An item of information from a marking of this kind may for example be an item of information relating to a workpiece transported on the marked transport means. In the case of workpieces requiring a lower processing quality, a faster feed rate can be set on the basis of this information, whereas in the case of transport apparatus which transport workpieces requiring a higher processing quality, a lower feed rate can be set. More efficient utilization of the transport device can thus be made possible.

Alternatively thereto, it is possible for an item of information relating to a state of the chain, for example relating to a chain length, to be obtained from reading out one or more markings. The feed rate can then be set on the basis of this information relating to the state of the chain.

### BRIEF DESCRIPTION OF THE FIGURES

FIG. 1 is an overview of a transport device for a workpiece according to an embodiment, given by way of example, of the present invention;

FIG. 2 is a perspective view of a transport apparatus according to an embodiment, given by way of example, of the present invention;

FIG. 3A shows an incremental pattern, by way of example, according to an embodiment, by way of example, of a transport device according to the present invention.

FIG. 3B shows an incremental scale, by way of example, according to an embodiment, by way of example, of a transport device according to the present invention.

FIG. 3C shows a further incremental scale, by way of example, according to a further embodiment, by way of example, of a transport device according to the present invention.

FIG. 3D shows an alternative embodiment of an incremental pattern or scale.

FIG. 4 is a flow diagram of a determination method of a position means along the first direction, according to an embodiment, given by way of example, of the present invention.

### DETAILED DESCRIPTION OF PREFERRED EMBODIMENTS

A preferred embodiment of the present invention will be described in the following, with reference to the accompanying drawings.

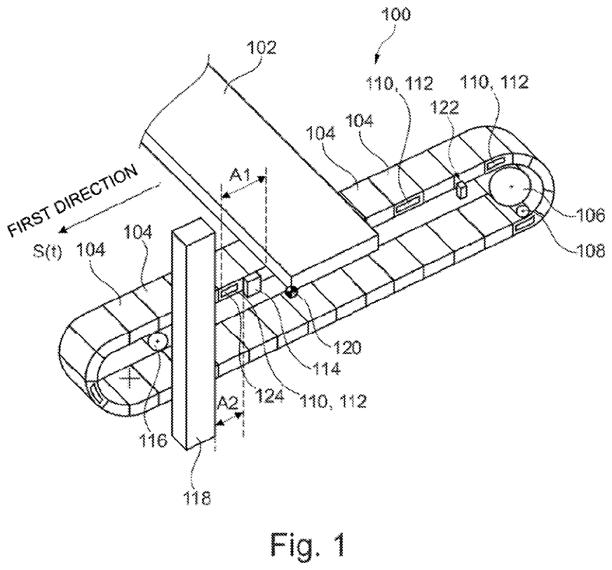

FIG. 1 is an overview of a transport device 100 for a workpiece according to an embodiment, given by way of example, of the present invention.

FIG. 1 is an overview of a transport device 100 for a workpiece 102 according to an embodiment, given by way of example, of the present invention.

The transport device 100 according to the present embodiment, by way of example, comprises a plurality of transport apparatus 104 which can move along the first direction, indicated by an arrow in FIG. 1. In the embodiment shown by way of example in FIG. 1, the transport apparatus 104 are configured such that they are annularly interconnected and result in a structure similar to a conveyor belt. The transport apparatus 104 may be configured so as to be rigid or flexible, but in any case such that the annular embodiment allows for movement. In the embodiment by way of example shown in FIG. 1, during operation of the transport device the transport apparatus 104 are moved, on the upper face, in a positive first direction, deflected about a first deflection roller (not shown), then moved in a negative first direction, and then deflected by a second deflection roller 106, such that they move in the first direction again. It is noted that the direction specifications in this embodiment by way of example are not limiting, and reverse operation is also possible. In the embodiment by way of example, shown in FIG. 1, driving of the transport apparatus 104 can be achieved by a drive 108. Devices for driving transport device of this kind are known to a person skilled in the art, and therefore a detailed description of the drive and of the speed control is omitted. A person skilled in the art furthermore knows how workpieces can be fastened to the transport means.

In the embodiment by way of example, shown in FIG. 1, the transport apparatus 104 can receive a workpiece 102. In the embodiment, by way of example, that is shown, the workpiece 102 is received and transported by a plurality of transport apparatus 104, but it is clear that the workpiece 102 can also be received by a single transport apparatus 104. In particular, it is clear that a transport device 100 can be configured such that, depending on the size of the workpieces 102 to be processed, it allows both for the reception and the transport of one or more workpieces 102 on a transport apparatus 104, and for operation in which a plurality of transport apparatus 104 transport a single workpiece 102.

In the embodiment, by way of example, that is shown, a marking 110 is applied to the side of some of the transport elements 104. It should be noted that, in the embodiment shown, a marking 110 is not applied to every transport apparatus 104, but an embodiment in which a marking 110 is applied to every transport apparatus 104 is also possible. The marking 110 comprises a pattern 112.

Furthermore, it should be noted that, in the embodiment by way of example, the transport device 100 displays exactly one workpiece 102, but in particular embodiments are possible in which a plurality of workpieces 102 are transported and/or processed simultaneously on one transport device 100.

The embodiment, by way of example, of the present invention shown in FIG. 1 further comprises a sensor means 114 which is configured such that it can read out a marking 110; in particular the sensor means 114 is configured such that it can read out the marking 110 while the transport device 100 is in operation, i.e. while the transport apparatus 102 move past said sensor means. It should be noted that the sensor means 114 is arranged such that, during operation of the transport device 100, the workpiece can move past said sensor means unimpeded. In the embodiment, by way of example, that is shown, the sensor means 114 is arranged below the trajectory of the lowest edge of the workpiece 102, such that the workpiece can move past said sensor means without hinderance.

The transport device 100 further comprises a plurality of support means 116, one of which is shown by way of example in FIG. 1, which support means guide the transport apparatus 104. Furthermore, in the embodiment by way of example in FIG. 1, a processing device 118 is shown, by way of example, on the transport device 100, past which processing device the workpieces 102 can be moved by the transport apparatus 104, and by which processing device said workpieces can be processed while the transport device 100 is in operation. The sensor device 114 can in particular be positioned precisely at the location at which the exact position of the workpiece 102 is required, for example in the direct vicinity of the processing device 118 or at the level of the processing region of the processing device 118 in the first direction.

FIG. 1 furthermore shows a reference point 120 on the workpiece 102, which denotes the front edge of the workpiece in the first direction and on the basis of which the position of the locations to be processed by the processing device 118 is determined.

The transport device 100 further comprises a board encoder (position switch) 122, which outputs a signal in the event of mechanical contact between a workpiece and a movable component on the upper face.

A path A1 denotes a spacing, measured in the first direction, between the reference point 120 of the workpiece and a reference point 124 of a marking 110.

It should be noted that in principle every marking 110 and every workpiece 102 comprise a reference point, which is located in each case at the frontmost end thereof in the first direction. For reasons of simplicity of illustration, however, only two of such reference points 120, 124 are shown in the embodiment, by way of example, shown in FIG. 1.

The spacing A1 between a reference point 124 of a marking 110 and a reference point 120 of a workpiece 102 can be determined for example in that a measuring signal of a sensor means 114 at which the sensor means 114 registers that a front end of a marking 110 is moving past it, is compared with a signal of the position switch 122 which is output when the front end of a workpiece 102 moves past it and actuates the movable component on the upper face.

It should be noted that, although in FIG. 1 the spacing A1 denotes the spacing between a reference point 120 of a workpiece 102 and a reference point 124 of an adjacent marking 110, spacings between reference points that are not directly adjacent can also be determined, in particular also those in which the workpiece is located further forward, in the first direction, than the marking from which the spacing is measured. In one embodiment, for a workpiece 102 the spacings along the first direction with respect to reference points 124 of a plurality of markings 110 are determined and stored; in a further embodiment that is not shown all the permutations of spacings between reference points 120 on workpieces 102 and reference points 124 on markings 110, both along the first direction and counter to the first direction, are determined and stored.

A second spacing A2 denotes the spacing between a reference point (not shown) of the sensor means 114 and a reference point (not shown) of the processing device 118. Even though the reference points can in principle be selected freely, and methods for converting distances in various reference systems are known to a person skilled in the art, in the embodiment by way of example the reference points are expediently the position of the measurement system in the first direction, at the level of which the sensor is located, and the position of the processing device in the first direction, at the level of which the tool is located.

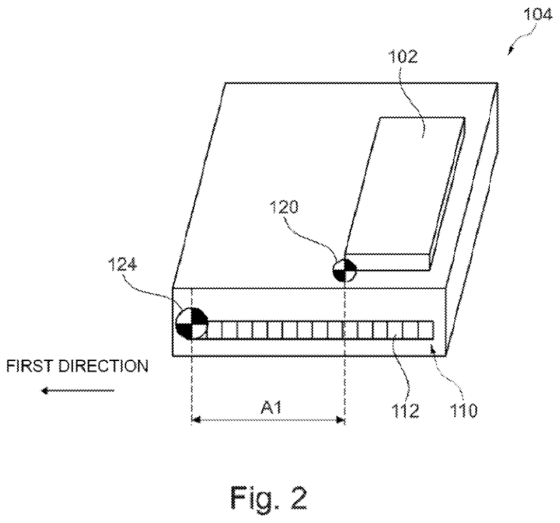

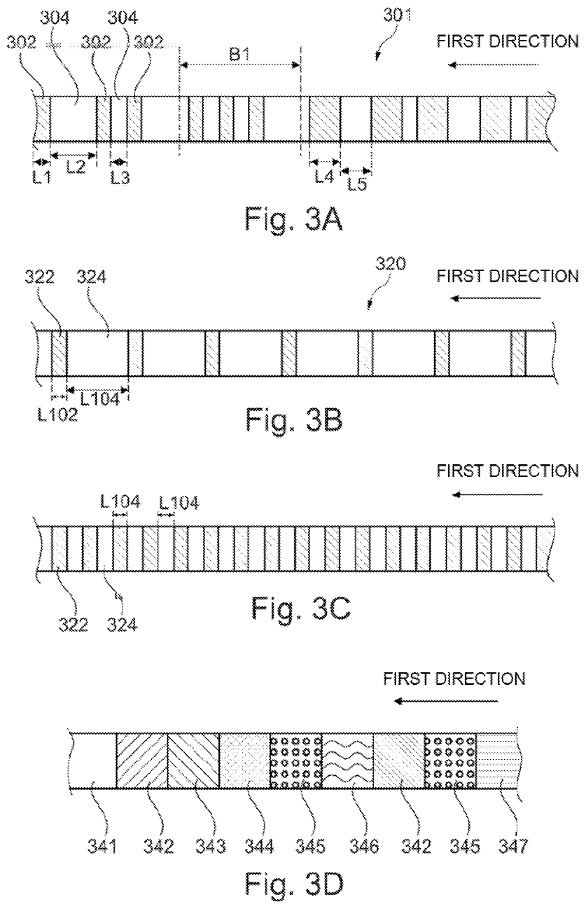

FIG. 2 is a perspective view of a transport apparatus 104 according to an embodiment, given by way of example, of the present invention, which is movable in the first direction, and to the lateral surface of which a marking 110 is applied, wherein the marking comprises a pattern 112 along the first direction. Embodiments and designs, by way of example, of the pattern 112 are also described with reference to FIG. 3A to 3D.

Furthermore, FIG. 2 shows a workpiece 102 which is arranged on a transport apparatus 104, and the reference point 120 at a front region of the workpiece 102 in a first direction, and the reference point 124 at a front region of the marking 110 in a first direction.

Furthermore, FIG. 2 shows the spacing A1 between the reference points 120 and 124.

FIGS. 3A, 3B, 3C and 3D show various embodiments, by way of example, of the pattern 112 according to the present invention.

FIG. 3A shows an embodiment, by way of example, of the present invention, wherein the pattern 112 is an example of an incremental pattern 301. An incremental pattern 301 comprises various alternating first regions 302 and second regions 304. In the embodiment, by way of example, of the incremental pattern 301 shown in FIG. 3A, the first regions are shown black, and the second regions white, but it should be noted that these drawings are merely for illustrative purposes, for example the first and second regions may be black and white, red and green, matt and gloss, or lighter and darker. In the event of the incremental pattern not being an optical pattern, the regions may for example also be magnetic regions, the magnetizations of which are oriented in opposing directions, or electronic communications chips which output different signals, for example a logical 1 and a logical 0.

For the sake of easier traceability, reference is made in the following to black 302 and white 304 regions. In the detail of the incremental pattern 301, shown in FIG. 3A, in the embodiment by way of example black 302 and white 304 regions alternate, wherein the lengths of the regions are not particularly restricted; in particular there can be regions present having a length in the first direction which differ from other regions. Thus, the black regions 302 may be of a first length L1 and a fourth length L4, and the white regions may be of a second length L2, a third length L3, and a fifth length L5. The detail of an incremental pattern 301, shown in FIG. 3A, is configured such that a sensor device (not shown), which detects a region B1 of the incremental pattern 301, determines what region of the incremental pattern is located in the region B1, on the basis of the sequence of black regions 302 and white regions 304 detected in the region B1, in combination with the lengths of the regions in the first direction, by means of a comparison with an item of information relating to the incremental pattern that is stored in the sensor device.

Furthermore, an item of information which specifies a distance between a reference point 124 of the marking (not shown in FIG. 3A-3D) and a point in the detected sub-region B1, can be stored in the sensor device of the embodiment by way of example.

The incremental pattern shown in FIG. 3A is configured such that it does not comprise two identical sub-regions of size B1.

The embodiment shown in FIG. 3A therefore makes it possible to position a marking relative to a position of a sensor unit, on the basis of a detection of a sub-region of the marking.

FIG. 3B shows an incremental scale 320, by way of example, according to an embodiment, by way of example, of a transport device according to the present invention. FIG. 3C shows a further incremental scale 330, by way of example, according to a further embodiment, by way of example, of a transport device according to the present invention. Even though the regions are again denoted, in this case, as black and white regions, the explanations made with regard to FIG. 3A apply correspondingly.

Within the meaning of this invention, reference is made to an incremental scale if at least one length of the length of the black regions L102 along the first direction or the length of the white regions L104 along the first direction is the same over the entire pattern and for. In other words: All the black regions 322 are of length L102 in the first direction, and/or all the white regions 324 are of length L104 in the first direction. An exception, in which the length L102 of the black regions 322 in the first direction is equal to the length L104 of the white regions 324 in the first direction, is shown in FIG. 3C.

In the embodiment by way of example, shown in FIGS. 3B and 3C, of an incremental scale, the position of a reference point of the marking relative to a reference point of the sensor device can be determined by a sensor device (not shown). If the incremental scale shown in FIGS. 3B and 3C moves past a sensor device in the first direction, the sensor device can detect the start of the marking, for example by detecting a first black region 322. In the event of the incremental scale being an optical incremental scale, the sensor device may be an optical sensor device, for example a camera or a laser transceiver device. In the event of the incremental scale being for example a magnetic incremental scale, the sensor device may be a magnetic reader.

For example, the sensor device can carry out a counting step every time a black region 322 passes through, such that, with knowledge of the length of each black region L102 in the first direction, and knowledge of the length of each white region L104 in the first direction, and the number of black regions passed through in the first direction, a spacing with respect to the first back region 322 can occur, wherein the accuracy or the resolution of the position determination increases with a decrease in length of the black regions 322 and of the white regions 324 in the first direction. On the basis thereof, it is possible to calculate the spacing in the first direction, between the sensor device and the reference point of the marking. On the basis thereof, and on the basis of knowledge of the spacing A1 between reference point 120 on the workpiece 102 and reference point 124 on the marking 110 in the first direction, as well as knowledge of the spacing A2 between a reference point on the sensor means 114 and a reference point on the processing device 118 in the first direction, it is thus possible to determine the relative position between a reference point on the processing device 118 and a reference point on the workpiece 102.

FIG. 3D shows an incremental pattern 340, by way of example, according to an embodiment, by way of example, of a transport device according to the present invention. Even though the regions are again denoted, in this case, as colored regions, the explanations made with regard to FIG. 3A apply correspondingly.

In the embodiment shown in FIG. 3D, differently configured regions 341, 342, 343, 344, 345, 346, 347 are shown, which illustrate that the incremental regions are not restricted to just two different designs, but rather can also comprise a plurality of different designs. In this case, for example, black regions 341, white regions 342, red regions 343, yellow regions 344, green regions 345, blue regions 346, and orange-colored regions 347, are conceivable, wherein the length of the individual regions, in the first direction, is not restricted.

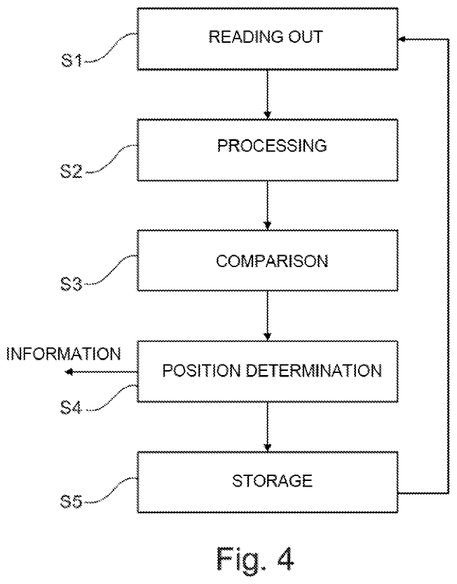

FIG. 4 is a flow diagram of a determination method of a position means along the first direction, according to an embodiment, given by way of example, of the present invention.

In a first step S1, a marking of a transport unit is read out. The reading out can for example include optical reading out of an incremental pattern or of an incremental scale.

In a second step S2, the information obtained from the reading out is processed; for example image data from an optical sensor unit are processed and edited such that optical structures can be identified, or magnetic field changes of a magnetic marking are converted into electronic data.

In a third step S3, a comparison is performed.

In the case of an incremental pattern as shown in FIG. 3A, this comparison may be a comparison of the information about a detected pattern with a stored pattern; in the case of an incremental scale, the comparison may for example be a comparison of an item of processed information with an item of information regarding what structure the incremental regions must have in order to be counted as an incremental step.

In a fourth step S4, a position determination is carried out on the basis of the results of the comparison.

In the case of an incremental pattern, this position determination can include, for example, a determination of a recorded region of the pattern, which is followed by a determination of the spacing of a point of the recorded region from a reference point 124 of the marking 110. A distance of the reference point 124 of the marking 110 from a reference point of the sensor means 114, in the first direction, results. The position of the reference point of the workpiece 102 relative to the reference point of the processing device 118 can now be determined, on the basis of the spacing between the reference point 124 and the sensor means 114 in the first direction, and of the known spacing between the reference point 120 on the workpiece 102 in the first direction and the reference point 124 on the marking 110, and of the known spacing between a reference point of the sensor unit 114 and a reference point of the processing device 118 in the first direction.

In the case of an incremental scale, this position determination can for example contain a determination of a number of increments passed through (i.e. for example black 322 or white 324 regions in FIG. 3B or 3C). With knowledge of the length of the increment regions in the first direction (i.e. for example the length L102 of the black regions 322 in the first direction and the length L104 of the white regions 324 along the first direction in FIG. 3B or 3C), having knowledge of the number of regions 322, 324 passed through, it is possible to determine the position of the marking 110 along the first direction, and thus the spacing of the reference point 124 of the marking 110 relative to a reference point of the sensor means 114, in the first direction. The position of the reference point of the workpiece 102 relative to the reference point of the processing device 118 can now be determined, on the basis of the spacing between the reference point 120 and the sensor means 114 in the first direction, and of the known spacing between the reference point 120 on the workpiece 102 and the reference point 124 on the marking in the first direction, and of the known spacing between a reference point of the sensor means 114 and a reference point of the processing device 118 in the first direction.

Following the position determination step S4, the position determined in the position determination step can be provided as information; for example it can be transmitted to a control unit (not shown) which controls the processing device 118 on the basis of the transmitted information.

Following the position determination step S4, in the embodiment by way of example in FIG. 4 the information relating to the determined position is stored in a storage step S5.

Following the storage step S5, the method can be performed again, beginning with the read-out step S1, wherein the stored information relating to the position of the transport apparatus 104 can be used for example as a basis for the comparison in step S3, such that it is possible to determine a current position, with respect to a fixed reference point, on the basis of the comparison of the change in a current position.

A method for determining the position of a workpiece 102 in a transport device 100 according to a further embodiment by way of example can be illustrated with reference to FIG. 2. In this case, the spacing between a reference point 124 of a marking 110 of a transport apparatus 104, and a reference point 120 of a workpiece 102, along a first direction, is measured, wherein the reference point 124 of the marking 110 is positioned at a front end of the marking 110 in the first direction, and the reference point 120 of the workpiece 102 is positioned at a front end of the workpiece 102, in the first direction. The method for position determination according to this embodiment by way of example comprises a step of determining the position of the reference point 120 of the workpiece 102 with respect to a reference point of the transport device 100, wherein the reference point of the transport device 100 is for example the sensor means 114. According to the embodiment by way of example, the method can comprise a determination of the position of the reference point 124 of the marking 110 relative to the transport device 100, as in the embodiment described above.

In an embodiment, by way of example, of the present invention that is not shown, the workpiece can be processed using a tool, on a transport device in a processing device 118. The workpiece can for example be milled, sawn, or chamfered. In the embodiment by way of example the workpiece 102 can be moved relative to the tool, in the processing device 118.

According to the embodiment described above, with knowledge of a relative position of the tool with respect to the transport device 100 along the first direction, and knowledge of a relative position of the workpiece 102 with respect to the transport device 100 in the first direction, it is possible to determine the relative position of the workpiece 102 with respect to the tool, using the above-described method for position determination.

### LIST OF REFERENCE CHARACTERS

100 transport device
102 workpiece
104 transport apparatus
106 deflection roller
108 drive
110 marking
112 pattern
114 sensor means
116 support means
118 processing device
120 reference point
122 position switch
124 reference point
301 incremental pattern
302 first region
304 second region
320 incremental scale
322 first region
324 second region
341 first region
342 second region
343 third region
344 fourth region
345 fifth region
346 sixth region
347 seventh region

1. Transport device for transporting workpieces, wherein the transport device comprises at least one transport apparatus which is configured such that it can move along a first direction, and wherein the transport apparatus comprises a marking which comprises a pattern along the first direction.

2. Transport device according to claim 1, wherein the transport apparatus can receive and transport a workpiece.

3. Transport device according to claim 1, wherein the marking is an optical marking, a metal marking, an inductive marking, or a magnetic marking.

4. Transport device according to claim 1, wherein the pattern is an incremental scale.

5. Transport device according to claim 1, wherein the marking is arranged on a lateral surface of the transport means.

6. Transport device according to claim 1, comprising at least one transport apparatus which does not comprise any marking.

7. Transport device according to claim 1, comprising a plurality of transport means, and wherein the transport apparatuses are annularly interconnected.

8. Transport device according to claim 1, comprising a sensor device for reading out the marking.

9. Transport device according to claim 8, wherein the transport apparatus is configured such that it moves along the first direction relative to the sensor device.

10. Transport device according to claim 8, wherein the sensor device is configured such that it can also move along a part of a path travelled by the transport means.

11. Method for determining a position of a transport apparatus along the first direction, wherein the method comprises the following steps:
reading out a region of the marking of a transport device according to claim 1, processing an item of information which is obtained from the reading out, storing the processed information,
comparing a processed item of information with stored information,
determining a change of a current position with respect to a previous position on the basis of the comparison and stored information.

12. Method for determining the position of a transport apparatus along a first direction according to claim 11, wherein the stored information comprises an item of information relating to the pattern of the marking.

13. (canceled)

14. Method for determining the position of a transport apparatus along a first direction according to claim 11, wherein the stored information comprises an item of information relating to the position of a transport apparatus prior to reading out the marking of the transport means.

15. Method for determining the position of a transport apparatus along a first direction according to claim 11, wherein a current position, with respect to a fixed reference point, is determined on the basis of the comparison of the change in a current position.

16. Method for determining the position of a workpiece in a transport device, comprising a step of determining a spacing between a reference point of a marking of a transport means, and a reference point of a workpiece.

17. Method for determining the position of a workpiece in a transport device according to claim 16, wherein the spacing in the first direction is measured.

18. Method for determining the position of a workpiece in a transport device according to claim 16, wherein the reference point of the marking is positioned at a front end of the marking, in the first direction.

19. Method for determining the position of a workpiece in a transport device according to claim 16, wherein the reference point of the workpiece is positioned at a front end of the workpiece, in the first direction.

20. Method for determining the position of a workpiece in a transport device according to claim 16, comprising a step of determining the position of the reference point of the workpiece with respect to a reference point of the transport device.

21. Method for determining the position of a workpiece in a transport device according to claim 16, wherein the transport device is a transport device according to claim 1.

22. Method for determining the position of a workpiece in a transport device according to claim 16, wherein the determination of the position of the reference point of the marking relative to the transport device comprises a method to claim 11.

23. (canceled)

24. (canceled)

25. (canceled)

26. (canceled)

27. (canceled)
